(19) United States
(12) Patent Application Publication
(10) Pub. No.: US 2020/0027080 A1
(43) Pub. Date: Jan. 23, 2020

(54) SCALABLE RECONCILIATION OF CRYPTO ASSETS IN A BLOCKCHAIN NETWORK

(71) Applicant: Regal RA DMCC, Dubai (AE)

(72) Inventors: Daniel Holland, Boise, ID (US); Ksenia Kiseleva, Dubai (AE); Vahagn Grigoryan, Yerevan (AM)

(21) Appl. No.: 16/038,680

(22) Filed: Jul. 18, 2018

(51) Int. Cl. G06Q 20/36; H04L 9/06; H04L 29/08

(52) U.S. Cl. CPC G06Q 20/3676; H04L 67/1042; H04L 9/0637

(57) ABSTRACT

A technique is provided for scalable reconciliation of a plurality of crypto assets between an offline wallet and an online wallet in a blockchain network. The technique includes receiving a request for reconciliation of a plurality of transactions from a trading platform; triggering the blockchain network to generate a smart contract, wherein the smart contract comprises information indicative of a quantity of the plurality of crypto assets to be shifted between the offline wallet and the online wallet; and reconciling the plurality of crypto assets between the offline wallet and the online wallet based on the generated smart contract and a public address, wherein the reconciling comprises transferring by the blockchain network a pre-defined number of a plurality of packets containing at least one of: a first part of a private multi-signature key and a second part of the multi-signature private key.

### TECHNICAL FIELD

This disclosure relates generally to transaction processing using smart contracts, and more particularly to system and method for scalable reconciliation of a plurality of crypto assets between an offline wallet and an online wallet in a blockchain network.

### INTRODUCTION

Transactional accounting systems track the quantity of assets held by various parties as well as the transfer of those assets between parties. The traditional implementation of these accounting systems includes a relational database that tracks the various transactions and an overall balance table that monitors the quantity of assets held by each party. As each transaction is executed, the balance table is updated to reflect the transfer of assets corresponding to the transaction.

### SUMMARY

In one embodiment, a method of scalable reconciliation of a plurality of crypto assets between an offline wallet and an online wallet in a blockchain network is disclosed. In one example, the method includes receiving, by one or more processors, a request for reconciliation of a plurality of transactions from a trading platform. The method further includes triggering, by the one or more processors, the blockchain network to generate a smart contract, wherein the smart contract comprises information indicative of a quantity of the plurality of crypto assets to be shifted between the offline wallet and the online wallet. The method further includes reconciling, by the one or more processors, the plurality of crypto assets between the offline wallet and the online wallet based on the generated smart contract and a public address. In an embodiment, the reconciling comprises transferring by the blockchain network a pre-defined number of a plurality of packets containing at least one of: a first part of a private multi-signature key and a second part of the multi-signature private key.

In another embodiment, a system is disclosed for scalable reconciliation of a plurality of crypto assets between an offline wallet and an online wallet in a blockchain network is disclosed. The system comprises a processor and a memory communicatively coupled to the processor. The memory stores processor-executable instructions, which, on execution, cause the processor to receive a request for reconciliation of a plurality of transactions from a trading platform. The processor may further trigger the blockchain network to generate a smart contract, wherein the smart contract comprises information indicative of a quantity of the plurality of crypto assets to be shifted between the offline wallet and the online wallet. The processor may further reconcile by the one or more processors, the plurality of crypto assets between the offline wallet and the online wallet based on the generated smart contract and a public address. In an embodiment, the reconciling comprises transferring by the blockchain network a pre-defined number of a plurality of packets containing at least one of: a first part of a private multi-signature key and a second part of the multi-signature private key.

In yet another embodiment, a non-transitory computer-readable medium storing computer-executable instructions for scalable reconciliation of a plurality of crypto assets between an offline wallet and an online wallet in a blockchain network is disclosed. In one example, the stored instructions, when executed by a processor, cause the processor to perform operations comprising receiving a request for reconciliation of a plurality of transactions from a trading platform. The stored instructions may further cause the processor to trigger the blockchain network to generate a smart contract, wherein the smart contract comprises information indicative of a quantity of the plurality of crypto assets to be shifted between the offline wallet and the online wallet. The stored instructions may further cause the processor to reconcile the plurality of crypto assets between the offline wallet and the online wallet based on the generated smart contract and a public address. In an embodiment, the reconciling comprises transferring by the blockchain network a pre-defined number of a plurality of packets containing at least one of: a first part of a private multi-signature key and a second part of the multi-signature private key.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary network environment for scalable reconciliation of a plurality of crypto assets between an offline wallet and an online wallet in a blockchain network, in accordance with some embodiments of the present disclosure.

FIG. 2 is a block diagram of exemplary system for scalable reconciliation of a plurality of crypto assets between an offline wallet and an online wallet in a blockchain network, in accordance with some embodiments of the present disclosure.

FIG. 3 is a flow diagram of a detailed exemplary process for deposit of crypto assets and scalable reconciliation of a plurality of crypto assets between an offline wallet and an online wallet in a blockchain network, in accordance with some embodiments of the present disclosure.

FIG. 4 is a flow diagram of a detailed exemplary process for withdrawal of crypto assets and scalable reconciliation of a plurality of crypto assets between an offline wallet and an online wallet in a blockchain network, in accordance with some embodiments of the present disclosure.

FIG. 5 is another flow diagram of a detailed exemplary process for withdrawal of crypto assets and scalable reconciliation of a plurality of crypto assets between an offline wallet and an online wallet in a blockchain network, in accordance with some embodiments of the present disclosure.

### DETAILED DESCRIPTION

A significant weakness of traditional accounting system database design arises from disconnect between the overall balance and the individual transactions that result in the overall balance. These conventional systems may only maintain the last state (e.g., an overall balance) and as such, there is no easy way to derive where the overall balance value came from and require extensive reconstruction of transactions in reconciliation. Therefore, in many scenarios, a detection of an error in one or more balance values results in a difficult reconciliation process. For example, clients often spend significant resources in the form of very large and/or entirely manual projects in an effort to track the source and to correct the discrepancy.

In these systems, both the quantity of an asset that is transferred in a transaction as well as the balance value of party are susceptible to being undesirably changed. These changes are often difficult to detect and can be nefarious in nature (e.g., hacking), thereby causing significant adverse effects. In extreme cases, accounting systems can be the target of hacking systems that cause large-scale changes or even downtime in the accounting system.

Further, existing transactions processing systems generate multi signature private keys online and any operator of the trading platform has complete access to the multi signature private keys. Thus, the smart contract may receive the multi signature private key on the blockchain and the smart contract may authorize the operator to allow the trading platform to transfer the funds. In such cases unconfirmed and dummy transactions may be performed and there may be loss of crypto currencies. This is a serious threat to the transactions processing systems and can be exploited by any hacker.

Therefore, and as Applicant recognized, there exists a need to provide a system and/or method for improving the security of crypto currencies and avoiding hacking/theft or unconfirmed and dummy transactions performed using blockchain.

In this regard, and as described below, Applicant developed system and methodology for scalable reconciliation of a plurality of crypto assets between an offline wallet and an online wallet in a blockchain network.

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

### Definitions

Cold storage: Cold storage refers to the process of storing crypto-currency such as, bitcoins offline, but the private keys associated with the process may be online and/or exposed to the internet at some time during the generation of the signing process. Deep cold storage, however, is a type of cold storage where not only are crypto-currency such as, bitcoins stored offline, but also the system that holds the crypto-currency were never online or connected to any kind of network. The private keys associated with that system were generated in offline systems, and the signing process of the transactions is also made in offline systems. The systems used in this type of storage never touch the Internet; they are created offline, they are stored offline, and they are offline when signing transactions. Cold storage may also be referred to as an offline wallet (e.g., as maintained by one or more of the offline systems).

Hot storage: Hot storage comprises any means for storing data in a form accessible to the processor or network on demand. For example, hot storage is online storage, app, cloud, or a crypto exchange account. Hot storage may also be referred to as an online wallet.

Vault: The vault contains one or more offline computer systems and one or more offline printers configured to print one or more multi-sig sealed keys, which are stored and catalogued in the vault. The purpose for keeping the one or more offline computer systems and one or more offline printers in the vault is for the machine which generates and prints private keys to not be compromised by any individuals, and the purpose for the printer to seal packages automatically is so that neither the trading platform operator or vault operator to be able to photograph the multi signature private keys.

Offline computer system refers to known in the art computer system that is not connected to the internet or any kind of communication network. Similarly, an offline printer refers to known in the art printing systems that is not connected to the internet or any kind of communication network.

Trading platform server: Trading platform server (e.g., referred to as a “trading platform”) may require regular/pre-defined reconciliation. Pre-defined period may correspond to monthly, regularly or on-demand reconciliation. The trading platform server may, when accessed by trading platform employees through a corresponding interface or remote terminal, instruct the trading platform employees to generate offline wallets by physically traveling to the vault which contains offline computer system and printer, printing multi-sig sealed keys, which are stored and catalogued in the vault, and then further sending the matching public addresses to register with the blockchain network. The trading platform server may further be configured to receive instructions from smart contracts to open sealed packets and scan to the specified address on the blockchain, multiple times as required.

Blockchain network: The blockchain network receives instructions to transfer crypto assets from its online wallets to the offline wallets. The blockchain network automatically transfers the crypto assets as the blockchain network has the public addresses registered in its system. A network-connected device or computing system operated by a party may provide a set of transactions, identifiers of the transactions, or details/attributes of the transactions to one or more computing systems operated by a central service provider such that the central service provider (e.g., via the one or more computing systems) can determine any discrepancies between the party's records and the recorded transactions in the blockchain. In some examples, the network-connected device or computing system operated by the party can transmit data across an appropriate communications network to the one or more computing systems of the central service provider via a secure, programmatic interface, such as an application programming interface (API) associated with the central service provider or with one or more application programs (e.g., web browsers, etc.) executed by the party's device or computing system, or with the one or more computer systems of the central service provider.

Once transactions are recorded, because the transactions are characterized by the hash value of the requested transaction and the hash value of the recorded transaction, these hash values become immutable through the further use of these hash values in the blockchain. Modifications to the transactions are prevented because later transactions in the blockchain rely on these hash values. A party thus cannot readily modify a transaction because discrepancies will not match for the transaction receipt or the transaction request when compared to the transaction details recorded in the blockchain. As one application of this approach, the blockchain network of the central service provider may serve as a contingency system for a primary transactions database (e.g., primary recordation system) that maintains the positions of assets held by different parties. The primary recordation system can request and subsequently verify executed transactions and party positions with the central service provider that maintains the blockchain records. This permits the primary recordation system to maintain its role in servicing requests from various parties while the blockchain system of the central service provider provides additional transaction verification and confirmation.

Smart contract: Reconciliation of transactions from a trading platform may trigger the blockchain network to generate the appropriate smart contract. The smart contract may comprise one or more rules/instructions that may correspond to shifting a quantity of crypto assets from online wallet to an off-line wallet or from the off-line wallet to the online-wallet. Further, the smart contract may maintain the opening balance and current running balance of the accounts as part of the reconciliation process. The smart contract is a part of the blockchain network and is used to securely manage the inventory in the vault. The smart contract may, when accessed by an appropriate network-connected device or computing system (e.g., through a remote procedure call protocol (such as a JSON-RPC protocol), a secure programmatic interface (such as an API), an executable application program, etc.), instruct the vault operator as well as the trading platform employee on their actions, the vault operator will not be authorized to take instruction from the trading platform employees. The vault operator can only get instructions and authorization through the smart contract via the corresponding network-connected device or computing system. The smart contract may instruct the vault operator to allow the trading platform employee to open one of the multi sig envelopes, and scan that private key and to send that private key to the exchanges hot wallet (e.g., across a communications network via the corresponding network-connected device or computing system). Only after the smart contract receives the private key on the blockchain, will the executed smart contract perform operations that authorize the vault operator to allow the trading platform company to view the other half of the multi-sig and transfer the other half, thereby making it impossible for the employee to steal the private key, and send it to their own wallet.

Crypto assets: A cryptocurrency or crypto assets can be defined broadly as any digital medium of exchange where units are produced according to a predefined, fixed mathematical formula (typically including principles of cryptography) yielding a decentralized system of creation and distribution, so that only a certain amount of cryptocurrency is produced by the entire cryptocurrency system collectively, and so that no group or individual may accelerate, stunt or in any other way significantly abuse the production of money. The term “crypto-currency” is sometimes regarded as short for “cryptographically-secured currency.” The term “crypto-currency”, “cryptographically-secured currency” and “crypto assets” have been interchangeably used in this disclosure.

Reconciliation: Reconciliation refers to changes in account values after a transaction occurs. Reconciliation may be performed after a predefined interval. In an embodiment, reconciliation may refer to moving/transferring of crypto assets in or out since we are only shifting the total volume above or below the current balance requested that hour, day or whichever interval is chosen) shifting of crypto assets from cold storage (off-line) to hot wallet (on-line) and vice-versa, which receive instructions from blockchain derived smart contracts

Multi-signature private keys: Multi-signature, also called multi-sig, is a security protocol that is part of the crypto assets/bitcoin core in which multiple private keys are required to sign a transaction. The technology is designed to increase the security of crypto assets/bitcoin storage. It is a technology that allows the generation of a bitcoin address that requires more than one private key and can require a specific combination of private keys (for example 3 out of 5 keys) to sign a crypto assets/bitcoin transaction before the crypto assets are released.

Packets: Each packet contains 1 of 2 multi sig private keys. Each packet further includes serial number to make it easy to track or match to its multi sig pair and public address, for purpose of organization and management.

Auditing/Insurance company auditor: Auditing/Insurance company auditor is configured to audit the process of creation of wallets.

Vault company operator: The vault company operator refers to a human being who takes instructions only from smart contracts, if vault company releases a packet without an authorization number from the smart contracts, then the liability falls on the insurance company, it will be the equivalent of the vault company releasing your gold bar to a stranger.

Trading platform operator: The trading platform operator/employee refers to a human being such as an employee of the trading platform company. The trading platform operator may generate offline wallets by physically travelling to the vault which contains the offline computer system and printer, printing multi sig individually sealed keys, which are stored and catalogued in the vault and then sending the matching public addresses to register with the blockchain network. The trading platform employee/operator may scan the QR code of the multi signature private key after opening the seal, and sends the information to the blockchain. The trading platform employee/operator takes instructions from smart contracts, printing packets and scanning QR codes to send or receive on behalf of the blockchain network.

Some of the following terms may be relevant to the subject matter disclosed herein. A Bitcoin/crypto currency address is similar to a physical address or an email. It is the only information you need to provide for someone to pay you with Bitcoin or various other digital/crypto currencies. An important difference, however, is that each address should only be used for a single transaction. The Block Chain (i.e., a “block”) is a public record of digital currency transactions in chronological order; the block chain is shared between all users. It is used to verify the permanence of Bitcoin transactions and to prevent double spending. Confirmation means that a transaction has been processed by the network and is highly unlikely to be reversed; each confirmation exponentially decreases the risk of a reversed transaction. Transactions receive a confirmation when they are included in a block and for each subsequent block. Multiple confirmations should be received to confirm large transactions but low value or low risk transactions may be accepted on the basis of a single confirmation.

### II. Exemplary Computer-Implemented Processes for Scalable Reconciliation of Cryptographic Assets in a Blockchain Network

The disclosed exemplary embodiments provide systems, apparatus, and methods for executing financial transactions using a digital currency (e.g., a crypto-currency), whereby a person is enabled to use a trading platform to send/receive cryptocurrency.

In some implementations, the trading platform (and other transaction account systems) may maintain a relational database that tracks various transfers of cryptocurrency between parties and an overall balance table that monitors the quantity of cryptocurrency held by each party. Upon execution of a cryptocurrency transfer, the trading platform may perform operations that, for each party, update the overall balance table to specify an overall balance of cryptocurrency that reflects the executed transfer.

However, a significant weakness of this design arises from disconnect between the overall balance and the individual transactions that result in the overall balance. These conventional systems may only maintain the last state (e.g., an overall balance) and as such, there is no easy way to derive where the overall balance value came from and require extensive reconstruction of transactions in reconciliation. Therefore, in many scenarios, a detection of an error in one or more balance values results in a difficult reconciliation process. For example, clients often spend significant resources in the form of very large and/or entirely manual projects in an effort to track the source and to correct the discrepancy.

In these systems, both the quantity of a cryptographic asset, such as cryptocurrency, that is transferred as well as the balance value of party are susceptible to being undesirably changed. These changes are often difficult to detect and can be nefarious in nature (e.g., hacking), thereby causing significant adverse effects. In extreme cases, accounting systems can be the target of hacking systems that cause large-scale changes or even downtime in the accounting system.

Further, conventional trading platforms and transactions processing systems generate multi signature private keys online and any operator of the trading platform has complete access to the multi signature private keys. Thus, the smart contract may receive the multi signature private key on the blockchain and the smart contract may authorize the operator to allow the trading platform to transfer the funds. In such cases unconfirmed and dummy transactions may be performed and there may be loss of crypto currencies. This is a serious threat to the transactions processing systems and can be exploited by any hacker.

Therefore, there exists a need to provide a system and/or method for improving the security of crypto currencies and avoiding hacking/theft or unconfirmed and dummy transactions performed using blockchain.

Some embodiments provide a system and apparatus, comprising dedicated hardware and logic (e.g., microchips and electronic components, software, mobile applications, server-based hosting and service provider infrastructure, crypto-currency definitions) and other means for providing a digital currency, wherein said digital currency can be stored and used in a handheld device by a user, and wherein said digital currency is exchangeable for fiat currencies and other types of credits, “points,” rewards, miles, rebates, and such means for exchanging financial instruments. The handheld device, which either is manufactured specifically for use with the system or is operating a compatible software application of the system, receives and transmits, displays and stores the digital currency in two modes, as “cold” and “hot,” that is, in a first mode where the device is off-line and a second mode where the device is connected to a network of the system.

The device comprises logic, either in a dedicated chip or in a dedicated software application, for providing a crypto-currency and one or more currency storage means whereby said crypto-currency held in storage represents a physical manifestation a digital currency. The device further provides regularly-updated conversion rate data and means for enabling the conversion of the crypto-currency into other fiat currencies and digital currencies. The device can communicate directly with other devices of the present invention during transactions between parties using the system of the invention, or it may execute transactions via a central server, such as a trading platform server or network provided by the invention. In variable embodiments, the device or an application running the software from a personal computer can transfer currencies with other devices and/or to another computer, cell phone, tablet or device on the network. Transfers/transactions may be conducted between two devices/applications in “cold” mode (i.e., cold to cold), two in “hot mode (hot to hot), and/or cold to hot/hot to cold. In particular, cold storage may apply to storage on a hard drive not connected to the internet or other network; hot storage may apply to storage available on websites for instant withdraw to specified address or in a state of active communication with a network.

Various implementations may be found in a method and/or a system to for scalable reconciliation of a plurality of crypto assets between an offline wallet and an online wallet in a blockchain network. The method and/or a system may receive a request for reconciliation of a plurality of transactions from a trading platform; trigger the blockchain network to generate a smart contract, wherein the smart contract comprises information indicative of a quantity of the plurality of crypto assets to be shifted between the offline wallet and the online wallet; and reconcile the plurality of crypto assets between the offline wallet and the online wallet based on the generated smart contract and a public address, wherein the reconciling comprises transferring by the blockchain network a pre-defined number of a plurality of packets containing at least one of: a first part of a private multi-signature key and a second part of the multi-signature private key.

The method and/or a system may further comprise generating the offline wallets comprising an offline computer system and a printer; printing a plurality of multi-signature private keys which are individually sealed and are catalogued in a vault; and sending a public address associated with each of the offline computer system and the printer to the blockchain network for registering the offline computer system and the printer.

In an embodiment, the reconciling further comprises: scanning the first part of the multi-signature private key stored in a multi sign envelope based on a first authorization/instruction received from the smart contract; sending the scanned first part of the private multi-signature key to the blockchain network; in response to receiving the scanned first part of the multi-signature private key, authorizing the trading platform to view the second part of the multi-signature private key; scanning the second part of the multi-signature private key stored in a multi sign envelope based on a second authorization/instruction received from the smart contract; and sending the scanned second part of the multi-signature private key to the blockchain network.

In an embodiment, method and/or a system may further comprise registering each of the plurality of packets on the smart contract, wherein equal denomination multi signature private keys are stored in each of the packets, wherein each packet contains at least one of: the first part of the multi-signature private key and the second part of the multi-signature private key, and a serial number, and a public address, wherein the plurality of multi-signature private keys are required to sign a single transaction.

In an embodiment, the reconciliation of the plurality of crypto assets between the offline wallet and the online wallet is performed after a pre-defined time interval. In an embodiment, the offline wallet corresponds to a cold storage. In an embodiment, the online wallet corresponds to a hot storage. In an embodiment, an trading platform operator has access to only one half of one packet at any instant of time, wherein the trading platform operator receives additional access to the vault after each confirmation on the blockchain.

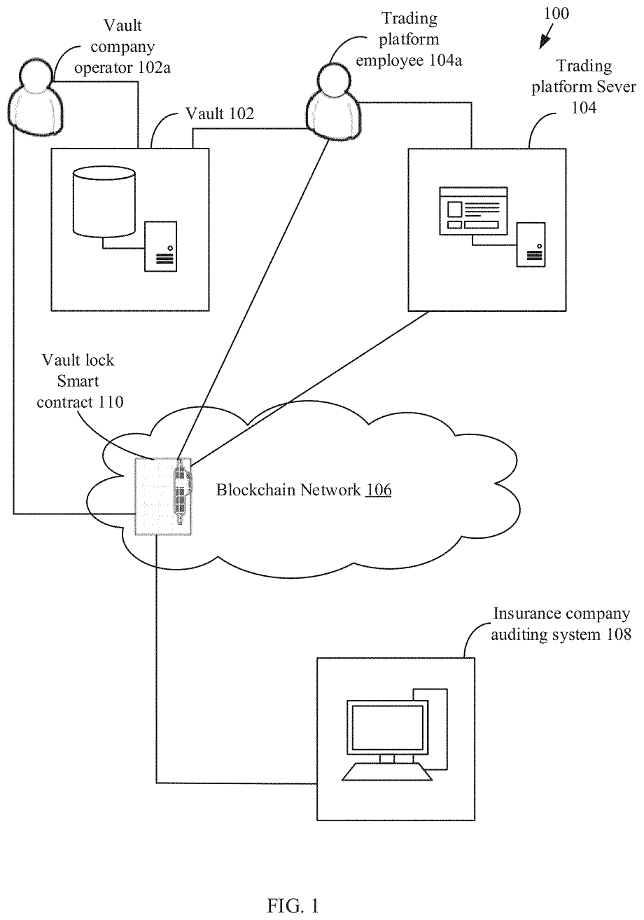

FIG. 1 is a block diagram of an exemplary network environment for scalable reconciliation of a plurality of crypto assets between an offline wallet and an online wallet in a blockchain network, in accordance with some embodiments of the present disclosure. The network environment may include a vault 102, a vault operator 102a, a trading platform server 104, a trading platform employee 104a, a block chain network 106 including a smart contract 110, and an insurance company auditing system 108.

The vault 102 contains one or more offline computer systems and one or more offline printers configured to print one or more multi-sig sealed keys, which are stored and catalogued in the vault 102. The purpose for keeping the one or more offline computer systems and one or more offline printers in the vault 102 is for the machine which generates and prints private keys to not be compromised by any individuals, and the purpose for the printer to seal packages automatically is so that neither the trading platform operator 104a or vault operator 102a to be able to photograph the multi signature private keys.

The vault company operator 102a refers to a human being who takes instructions only from smart contracts, if vault company releases a packet without an authorization number from the smart contracts, then the liability falls on the insurance company, it will be the equivalent of the vault company releasing your gold bar to a stranger.

The trading platform server 104 or the trading platform may be referred to as an entity requiring regular/pre-defined reconciliation. Pre-defined period may correspond to monthly, regularly or on-demand reconciliation. The trading platform may instruct the trading platform employees 104a to generate offline wallets by physically traveling to the vault which contains offline computer system and printer, printing multi-sig sealed keys, which are stored and catalogued in the vault 102, and then further sending the matching public addresses to register with the block chain network 106. The trading platform server 104 may further be configured to receive instructions from smart contracts 110 to open sealed packets and scan to the specified address on the block chain, multiple times as required.

The trading platform operator/employee 104a refers to a human being such as an employee of the trading platform company. The trading platform operator 104a may generate offline wallets by physically travelling to the vault 102 which contains the offline computer system and printer, printing multi sig individually sealed keys, which are stored and catalogued in the vault and then sending the matching public addresses to register with the block chain network. The trading platform employee/operator 104a may scans the QR code of the multi signature private key after opening the seal, and sends the information to the block chain. The trading platform employee/operator 104a takes instructions from smart contracts 110, printing packets and scanning QR codes to send or receive on behalf of the block chain network 106.

The Block Chain (i.e., a “block”) is a public record of digital currency transactions in chronological order; the block chain 106 is shared between all users. It is used to verify the permanence of Bitcoin transactions and to prevent double spending. Confirmation means that a transaction has been processed by the network and is highly unlikely to be reversed; each confirmation exponentially decreases the risk of a reversed transaction. Transactions receive a confirmation when they are included in a block and for each subsequent block. Multiple confirmations should be received to confirm large transactions but low value or low risk transactions may be accepted on the basis of a single confirmation. The block chain network 106 receives instructions to transfer crypto assets from its online wallets to the offline wallets. The block chain network 106 automatically transfers the crypto assets as the block chain network 106 has the public addresses registered in its system

Reconciliation of transactions from a trading platform may trigger the block chain network 106 to generate the appropriate smart contract 110. The smart contract 110 may comprise one or more rules/instructions that may correspond to shifting a quantity of crypto assets from online wallet to an off-line wallet or from the off-line wallet to the online-wallet. Further, the smart contract 110 may maintain the opening balance and current running balance of the accounts as part of the reconciliation process. The smart contract is a part of the block chain network 106 and is used to securely manage the inventory in the vault 102. The smart contract 110 may instruct the vault operator 102a as well as the trading platform employee 104a on their actions, the vault operator 102a will not be authorized to take instruction from the trading platform employees 104a. The vault operator 102a can only get instructions and authorization through the smart contract 110. The smart contract 110 may instruct the vault operator 102a to allow the trading platform employee 104a to open one of the multi sig envelopes, and scan that private key and to send that private key to the exchanges hot wallet. Only after the smart contract 110 receives the private key on the block chain network 106, will it authorize the vault operator 102a to allow the trading platform company to view the other half of the multi-sig and transfer the other half, thereby making it impossible for the employee to steal the private key, and send it to their own wallet.

The insurance company auditing system 108 includes an auditing/insurance company auditor is configured to audit the process of creation of wallets.

In operation, a plurality of client devices may request the trading platform server 104 to move/transfer crypto assets from cold storage (off-line) to hot wallet (on-line) and vice versa, which receive instructions from block chain network 106 derived smart contracts 110. Reconciliation of transactions from the trading platform server 104 will trigger the block chain network 106 to generate the appropriate smart contract 110. The smart contract 110 may contain rules indicative of whether to shift a quantity of crypto assets from online wallet to an off-line wallet or from the off-line wallet to the online-wallet. The trading platform server 104 may be configured to shift the total volume above or below the current balance requested that hour, day or whichever predefined interval is chosen.

The trading platform server 104 may perform two types of transactions such as a deposit (transfer in) and a withdrawal (transfer out) at any time. While performing the deposit (transfer in) transaction, the trading platform operator 104a may generate offline wallets by physically travelling to the vault 102 which contains offline computer system and offline printer. The offline printer may be configured to print multi sig individually sealed private keys. The sealed multi sig private keys are stored and catalogued in the vault 102. The trading platform operator 104a may then send the matching public addresses associated with each of the sealed multi sig private keys to register with the block chain network 106. The offline computer system and offline printer are kept in the vault 102 so that computer system/machine which generates and prints private keys should not be compromised by any individuals, and the purpose for the printer to seal packages automatically is that neither the trading platform operator 104a or the vault operator 102a be able to photograph the multi sig keys.

In response to receiving instructions by the blockchain network 106 to transfer crypto assets from its online wallets to the offline wallets, the blockchain network 106 automatically transfers the crypto assets based on the public addresses registered in its system. In this manner the deposit transaction is executed.

While performing the withdrawal (transfer out) transaction, each packet of the plurality of packets is registered on a smart contract from the blockchain network 106. In an embodiment, each packet contains at least one of: a first part of the multi-signature private key and a second part of the multi-signature private key, and a serial number, and a public address. In an embodiment, the plurality of multi-signature private keys is required to sign a single transaction.

In an embodiment, equal denomination multi signature private keys are stored in each of the packets. Equal denomination multi signature private keys are stored in each of the packets as it provides an improved method for reconciliation of transactions if all pairs of multi signature private keys hold a specific/predefined amount. For example, the multi signature private keys can hold 10 BTCs, 50 BTCs, 100 BTCs. In an embodiment, there may be 3-4 sets of denominations.

After multi signature private keys are stored in each of the packets, the trading platform server 104 is configured to periodically reconcile fluctuation from hot storage to deep cold storage based on a smart contract 110. In an embodiment, the reconciling comprises shifting a pre-defined number of packets containing one of two multi-signature private keys by the blockchain network 106 based on the smart contract 110. Thus, if 3,600,000 USD worth of Bitcoin is to be transferred then the smart contract 110 can reduce the amount of transactions without transferring too much more than necessary. For instance, assuming 1 BTC (Bitcoin) is valued at $10,000: The smart contract would request a transfer of: 3 pairs of 100 BTC packets=$3,000,000, 1 pair 50 BTC packet=$500,000, 1 pair 10 BTC packet=$100,000, thus the Total is $3,600,000.

In an embodiment, during reconciliation the trading platform operator 104a is configured to receive from a vault company operator 102a a first authorization key for a packet based on the generated smart contract. In an embodiment, the subsequent authorization key for another subsequent packet is received only after successful transfer to a designated address. After the first authorization key is transferred then transfer individually each matching private key pair to the blockchain network 106 to complete the final stage of reconciliation. In an embodiment, trading platform operator has access to only one half of one packet at any instant of time. In an embodiment, the trading platform operator 104a receives additional access to the vault 102 after each confirmation on the blockchain network 106.

In an embodiment, during reconciliation the trading platform operator 104a is configured to scan the first part of the multi-signature private key stored in a multi sign envelope based on a first authorization/instruction received from the smart contract 110. After scanning, the trading platform operator 104a sends the scanned first part of the private multi-signature key to the blockchain network 106. In response to receiving the scanned first part of the multi-signature private key, authorizing the trading platform operator 104a to view the second part of the multi-signature private key. After viewing the second part, the trading platform operator 104a may scan the second part of the multi-signature private key stored in a multi sign envelope based on a second authorization/instruction received from the smart contract 110. Then the trading platform operator 104a sends the scanned second part of the multi-signature private key to the blockchain network 110.

For example, the trading platform operator 104a may receive instructions from smart contracts 110 to open sealed packets and scan to the specified address on the blockchain network 106, multiple times as required, for the below example:

Transaction request: Send to hot wallet 3,600,000 USD. Thus, the trading platform operator 104a will need 10 scans. 5 scans of each half private keys, 10 scans total, each time requiring confirmation from smart contracts 110 for vault operator 102a to release following packet.
3 pairs of 100 BTC packets=$3,000,000
1 pair 50 BTC packet=$500,000
1 pair 10 BTC packet=$100,000
Total $3,600,000

As the multi sig private keys are created offline from a computer which will be audited by the trading platform company and the insurance company representing the vault 102 company the disclosed method and system protects theft or misappropriation of transactions. The printer, prints and seals the packet, these packets are made once every 6 months or on demand in the vault 102, then all the multi sig private keys stay in the vault 102 and all the public keys are sent to the blockchain network 106, this complete process is done under the supervision of the insurance company. Therefore at this point if theft is done, it will be borne by the insurance company, thereby protecting the consumer funds. The smart contract 110 will be instructing the vault operator 102a as well as the trading platform operator 104a on their actions, the vault operator 102a will not be authorized to take instruction from the trading platform operator 104a. The vault operator 102a can only get instructions and authorization through the smart contract 110. The smart contract 110 will instruct the vault operator 102a to allow the trading platform operator 104a to open one of the multi sig envelopes, and scan that private key and to send that private key to the exchanges hot wallet. Only after the smart contract 110 receives the private key on the blockchain network 106, will it authorize the vault operator 102a to allow the trading platform operator 104a to view the other half of the multi-sig and transfer the other half, thereby making it impossible for the employee to steal the private key, and send it to their own wallet. Even if any of the half private keys are stolen then the transaction will be unconfirmed as both the private keys are not submitted and thus the smart contract 110 will not release the second private key if it does not register the first private key to its address.

It should be noted that the various modules described above may be implemented in programmable hardware devices such as programmable gate arrays, programmable array logic, programmable logic devices, and so forth. Alternatively, the various modules described above may be implemented in software for execution by various types of processors. An identified module of executable code may, for instance, include one or more physical or logical blocks of computer instructions which may, for instance, be organized as an object, procedure, function, engine, or other construct. Nevertheless, the executables of an identified module need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for transmitting data over a communication network. For example, the exemplary network environment 100 may transmit data over a communication network by the processes discussed herein. In particular, as will be appreciated by those of ordinary skill in the art, control logic and/or automated routines for performing the techniques and steps described herein may be implemented by the network environment 100, either by hardware, software, or combinations of hardware and software. For example, suitable code may be accessed and executed by the one or more processors on the network environment 100 to perform some or all of the techniques described herein. Similarly, application specific integrated circuits (ASICs) configured to perform some or all of the processes described herein may be included in the one or more processors on the network environment 100.

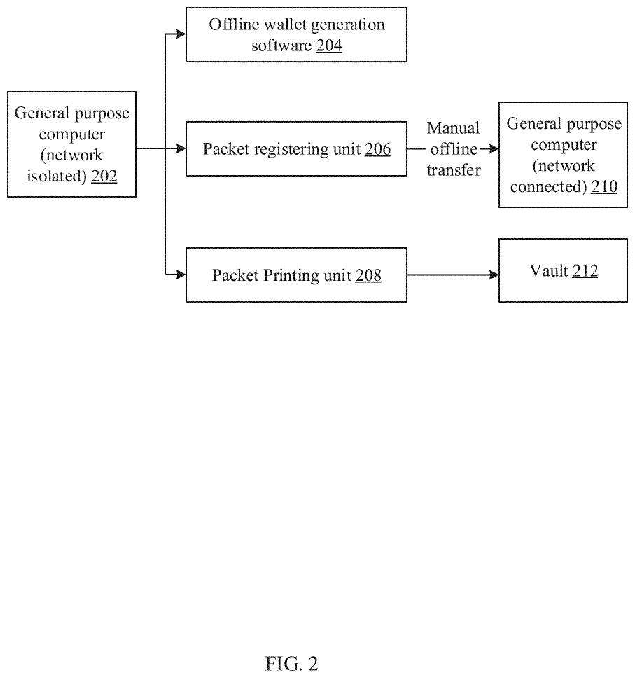

FIG. 2 is a block diagram of exemplary system for scalable reconciliation of a plurality of crypto assets between an offline wallet and an online wallet in a blockchain network 106, in accordance with some embodiments of the present disclosure. FIG. 2 is explained in conjunction with elements from FIG. 1. With reference to FIG. 2, there is shown a general purpose computer 202 which is not connected to any network, offline wallet generation software 204, packet registering unit 206, packet printing unit 208, the general purpose computer 210 which is connected to the network and the vault 212.

The general purpose computer 202 works in conjunction with the other entities as shown in FIG. 2. The trading platform operator, insurance agents and the auditors physically travel to the vault for initiating the transactions. While the auditors and the insurers observe the offline key generation program instructs the packet printing unit to print the multisig keys. In the presence of the insurance agents and the auditors the packet registering unit 206 performs a manual offline transfer to the general purpose computer that is connected to the network 210. The printed multisig keys are stored and catalogued in the vault 212. The packet registering unit 206 records the offline wallet public address to the blockchain smart contract. The smart contract includes instructions whether to shift a quantity of crypto assets from online wallet to an off-line wallet or from the off-line wallet to the online-wallet. The smart contract may send instructions to the trading platform operator 104a and/or the vault operator to open the sealed packets and to scan to the specified address on the blockchain network 106.

The packet registering unit 208 may include suitable logic, circuitry, interfaces, and/or code that may be configured to generate the packets where Each packet contains 1 of 2 multi sig private keys, as a serial number to make it easy to track or match to its multi sig pair and public address, for purpose of organization and management. In an embodiment, the packet registering unit 208 may make the packets once every 6 months or on demand in the vault 102.

In operation, during deposit transactions the trading platform operator may generate offline wallets by physically travelling to the vault which contains offline computer system and printer, printing multi sig individually sealed keys, which are stored and are catalogued in the vault. The smart contract generated may send instructions to transfer crypto assets from its online wallets to the offline wallets via the blockchain network. The blockchain network automatically transfers the crypto assets to the public addresses registered in its system based on the smart contract.

During withdrawal transactions, the packet registering unit 208 may register each packet on the smart contract. In an embodiment, equal denomination multi-signature private keys are stored in each of the packets. After the packets are generated and registered, the reconciliation unit 210 may be configured to periodically reconcile fluctuation of crypto assets from hot storage to deep cold storage based on the smart contract and the packets. The reconciling comprises shifting a pre-defined number of packets containing one of two multi-signature private keys by the blockchain based on the smart contract. In an embodiment, the vault operator may receive a first authorization key for a packet, wherein the subsequent authorization key for another subsequent packet is received only after successful transfer to a designated address. After this the each matching private key pair is transferred individually to the blockchain to complete the final stage of reconciliation. In an embodiment, trade platform operator has access to only one half of one packet at any instant of time, wherein the trade platform operator receives additional access to the vault after each confirmation on the blockchain.

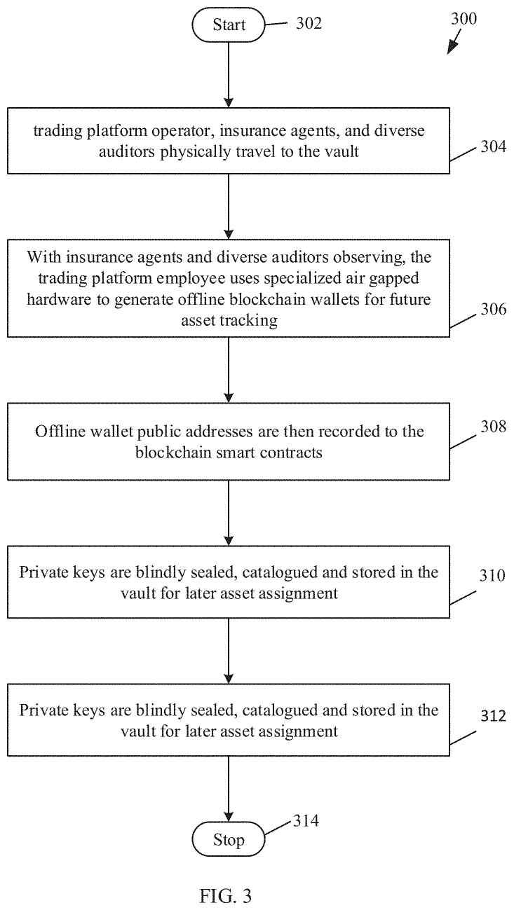

FIG. 3 is a flow diagram of a detailed exemplary process for depositing crypto assets and scalable reconciliation of a plurality of crypto assets between an offline wallet and an online wallet in a blockchain network, in accordance with some embodiments of the present disclosure. With reference to FIG. 3, there is shown a flow chart 300. The flow chart 300 is described in conjunction with FIGS. 1 to 2. The process starts at step 302 and proceeds to step 304.

At step 304, the trading platform operator, insurance agents and the diverse auditors physically travel to the vault. At step 306, the insurance agents and the diverse auditors observe the activities of the trading platform employee. The trading platform employee uses specialized air gapped hardware to generate the offline blockchain wallets for future asset tracking. At step 308, the offline wallet public address is then recorded to the blockchain smart contracts. At step 310, private keys are blindly sealed, catalogued and stored in the vault for later asset assignment. At step 312, when a deposit is made to the vault, an unused wallet is assigned as the key to that asset. The assignment is recorded to the smart contract and stands as the only key that can authorize a withdrawal. The control passes to end step 312.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The disclosed methods and systems may be implemented on a conventional or a general-purpose computer system, such as a personal computer (PC) or server computer.

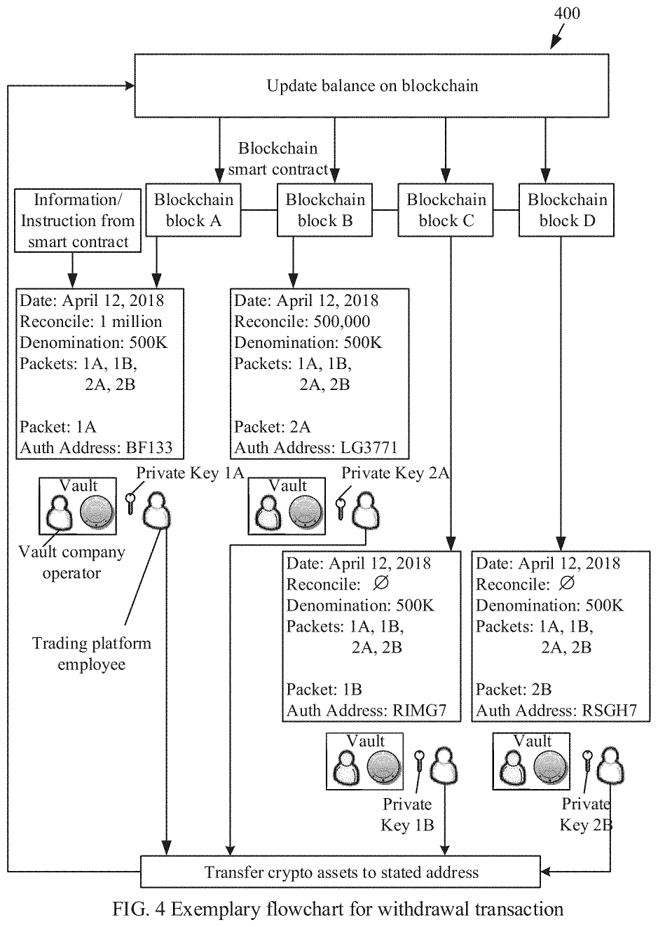

FIG. 4 is a flow diagram 400 of a detailed exemplary process for withdrawal of crypto assets and scalable reconciliation of a plurality of crypto assets between an offline wallet and an online wallet in a blockchain network, in accordance with some embodiments of the present disclosure. As shown in FIG. 400, the blockchain consists of blocks such as, blockchain block A, blockchain block B, blockchain block C, blockchain block D and the blockchain smart contract that provides information/instructions for reconciliation of crypto assets such as, bitcoins. For example, a withdrawal transaction of 1 million is to be reconciled then transaction is performed using 2 pair of multi signature packets. First pair of the multi-sig packet include the private key 1A and 1B. Second pair of the multi-sig packet include the private key 2A and 2B.

Further, each of the packets includes 1 of 2 multi sig private keys such as 1A, 1B and 2A, 2B. Each packet further includes serial number to make it easy to track or match to its multi sig pair and public address such as BF133, LG3771, RIMG7, and SGH7, for purpose of organization and management. Each of the 2 pair of multi signature packets are registered on the smart contract. In an embodiment, equal denomination multi-signature private keys are stored in each of the packets such as 500K as shown in FIG. 6. In an embodiment, a vault company receives a first authorization key for a packet, wherein the subsequent authorization key for another subsequent packet is received only after successful transfer to a designated address. The smart contract instructs the vault operator to allow the trading platform employee to open one of the multi sig envelope, and scan that private key 1A and to send that private key to the exchanges hot wallet. Only after the smart contract receives the private key 1A on the blockchain, will it authorize the vault operator to allow the trading platform company to view the other half of the multi-sig i.e. 1B and transfer the other half, thereby making it impossible for the employee to steal the private key, and send it to their own wallet.

Similarly, the smart contract instructs the vault operator to allow the trading platform employee to open one of the multi sig envelope, and scan that private key 2A and to send that private key to the exchanges hot wallet. Only after the smart contract receives the private key 2A on the blockchain, will it authorize the vault operator to allow the trading platform company to view the other half of the multi-sig i.e. 2B and transfer the other half. The vault contains one or more offline computer systems and one or more offline printers configured to print one or more multi-sig sealed keys, such as 1A, 1B, 2A and 2B, which are stored and catalogued in the vault. The purpose for keeping the one or more offline computer systems and one or more offline printers in the vault is for the machine which generates and prints private keys, such as 1A, 1B, 2A and 2B to not be compromised by any individuals, and the purpose for the printer to seal packages automatically is so that neither the trading platform operator or vault operator to be able to photograph the multi signature private keys.

Thus, periodic reconciliation from hot storage to deep cold storage is performed based on the smart contract instructions. As illustrated in FIG. 6 and as described above, a pre-defined number of packets are shifted containing one of two multi-signature private keys by the blockchain based on the smart contract. The system described herein individually transfers each matching private key pair to the blockchain to complete the final stage of reconciliation and transfers the bitcoins/crypto assets to stated public address. In an embodiment, the operator has access to only one half of one packet at any instant of time, wherein the operator receives additional access to the vault after each confirmation on the blockchain and the balance is updated on the blockchain.

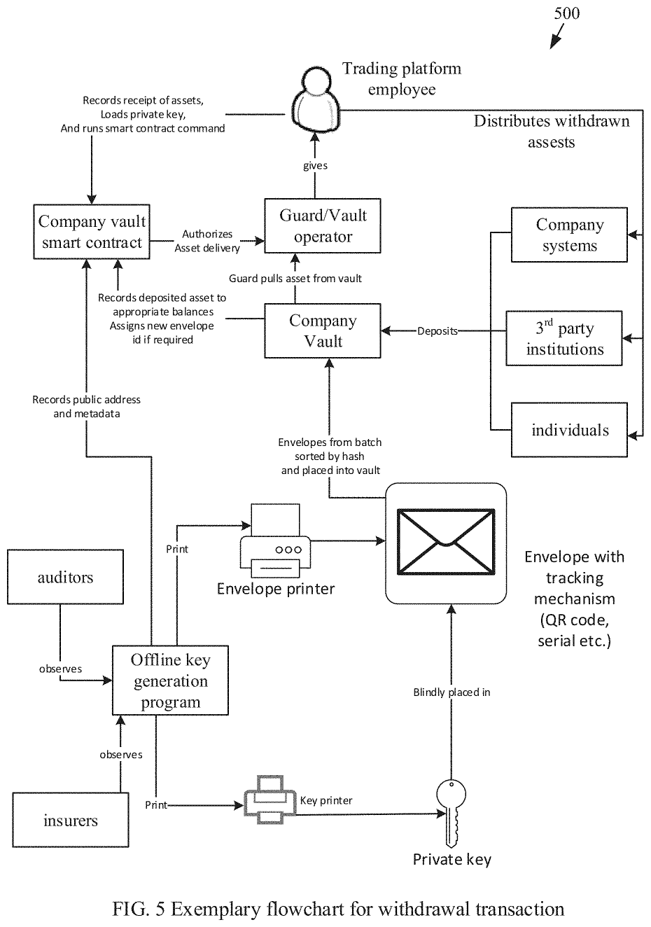

FIG. 5 is another flow diagram 500 of a detailed exemplary process for withdrawal of crypto assets and scalable reconciliation of a plurality of crypto assets between an offline wallet and an online wallet in a blockchain network, in accordance with some embodiments of the present disclosure.

As shown in FIG. 500, company systems, 3rd party institutions and individuals may perform the deposit transaction in the company vault. The auditors and the insurers observe while the key generation program prints the private key using the key printer and the envelope printer prints the secured envelope that contains the printed private key, serial number, QR code and the like. Such secure envelopes in each batch are sorted by hash value and placed and stored/catalogued in the company vault. Further, the offline key generation program records the public address and the metadata in the company smart contract on the blockchain network. Each time company systems, 3rd party institutions or individuals perform a deposit transaction, the company vault records the deposited crypto asset to appropriate balances. In an embodiment, the company vault may assign new envelope id if required.

Thus, the employees of the trading platform company generate offline wallets by physically travelling to the vault which contains offline computer system and printer, printing multi sig individually sealed keys, which remain and get catalogued in the vault, then the matching public addresses are sent to register with the blockchain network. When the blockchain network receives instructions to transfer crypto assets from its online wallets to the offline wallets, it does so automatically as it has the public addresses registered in its system.

When a withdrawal transaction is initiated by any of the parties then the smart contract authorizes the delivery of crypto assets to the guard/vault operator. Based on the instruction received from the smart contract the guard/vault operator pulls the crypto assets out of the vault. The trading platform employee receives the crypto assets from the vault operator based on the instructions received from the smart contract. The trading platform employee records the receipt of the crypto assets, loads the pair of private keys and runs the smart contract command. Further, based on the command received from the smart contract the trading platform employee distributes the crypto assets to all the parties who has received the withdrawal transaction.

The smart contract will be instructing the vault operator as well as the trading platform employee on their actions, the vault operator will not be authorized to take instruction from the trading platform employees. The vault operator can only get instructions and authorization through the smart contract. The smart contract will instruct the vault operator to allow the trading platform employee to open one of the multi sig envelopes, and scan that private key and to send that private key to the exchanges hot wallet. Only after the smart contract receives the private key on the blockchain, will it authorize the vault operator to allow the trading platform company to view the other half of the multi-sig and transfer the other half, thereby making it impossible for the employee to steal the private key, and send it to their own wallet. Thus, periodically reconciling fluctuation from hot storage to deep cold storage is performed based on the smart contract, wherein the reconciling comprises shifting a pre-defined number of packets containing one of two multi-signature private keys by the blockchain based on the smart contract.

As will be appreciated by those skilled in the art, the techniques described in the various embodiments discussed above provide scalable reconciliation of crypto assets in a blockchain network. In the disclose technique the private keys are created offline from a computer which will be audited by the trading platform company and the insurance company representing the vault company. The printer, prints and seals the packet, these packets are made once every 6 months or on demand in the vault, then all the private keys stay in the vault and all the public keys are sent to the blockchain, this complete process is done under the supervision of the insurance company. Therefore at this point if theft is done, it will be borne by the insurance company, making consumer funds protected. The smart contract will be instructing the vault operator as well as the trading platform employee on their actions, the vault operator will not be authorized to take instruction from the trading platform employees. The vault operator can only get instructions and authorization through the smart contract. The smart contract will instruct the vault operator to allow the trading platform employee to open one of the multi sig envelopes, and scan that private key and to send that private key to the exchanges hot wallet. Only after the smart contract receives the private key on the blockchain, will it authorize the vault operator to allow the trading platform company to view the other half of the multi-sig and transfer the other half, thereby making it impossible for the employee to steal the private key, and send it to their own wallet. Thus, the disclosed invention provides an improved method for scalable reconciliation of crypto assets in a blockchain network and theft of crypto assets and misappropriation of transactions is avoided.

The specification has described system and method for scalable reconciliation of crypto assets in a blockchain network. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for scalable reconciliation of a plurality of crypto assets between an offline wallet and an online wallet in a blockchain network, the method comprising:
receiving, by one or more processors, a request for reconciliation of a plurality of transactions from a computing system associated with a trading platform;
triggering, by the one or more processors, the blockchain network to generate a smart contract, wherein the smart contract comprises information indicative of a quantity of the plurality of crypto assets to be shifted between the offline wallet and the online wallet; and
reconciling, by the one or more processors, the plurality of crypto assets between the offline wallet and the online wallet based on the generated smart contract and a public address, wherein the reconciling comprises transferring by the blockchain network a pre-defined number of a plurality of packets containing at least one of: a first part of a private multi-signature key and a second part of the multi-signature private key.

2. The method of claim 1, further comprising:
generating the offline wallets comprising an offline computer system and a printer;
printing a plurality of multi-signature private keys which are individually sealed and are catalogued in a vault; and
sending a public address associated with each of the offline computer system and the printer to the blockchain network for registering the offline computer system and the printer.

3. The method of claim 1, wherein the reconciling further comprises:
scanning the first part of the multi-signature private key stored in a multi sign envelope based on a first authorization/instruction received from the smart contract;
sending the scanned first part of the private multi-signature key to the blockchain network;
in response to receiving the scanned first part of the multi-signature private key, authorizing the trading platform to view the second part of the multi-signature private key;
scanning the second part of the multi-signature private key stored in a multi sign envelope based on a second authorization/instruction received from the smart contract; and
sending the scanned second part of the multi-signature private key to the blockchain network.

4. The method of claim 1, further comprising registering each of the plurality of packets on the smart contract, wherein equal denomination multi signature private keys are stored in each of the packets, wherein each packet contains at least one of: the first part of the multi-signature private key and the second part of the multi-signature private key, and a serial number, and a public address, wherein the plurality of multi-signature private keys is required to sign a single transaction.

5. The method of claim 1, wherein the reconciliation of the plurality of crypto assets between the offline wallet and the online wallet is performed after a pre-defined time interval.

6. The method of claim 1, wherein the offline wallet corresponds to a cold storage.

7. The method of claim 1, wherein the online wallet corresponds to a hot storage.

8. The method of claim 1, wherein an operator has access to only one half of one packet at any instant of time, wherein the operator receives additional access to the vault after each confirmation on the blockchain.

9. A system for scalable reconciliation of a plurality of crypto assets between an offline wallet and an online wallet in a blockchain network, the system comprising:
one or more hardware processors; and
a memory coupled to the one or more hardware processors, the memory storing instructions for execution by the one or more hardware processors, wherein the one or more hardware processors are configured by the instructions to:
receive a request for reconciliation of a plurality of transactions from a computing system associated with trading platform;
trigger the blockchain network to generate a smart contract, wherein the smart contract comprises information indicative of a quantity of the plurality of crypto assets to be shifted between the offline wallet and the online wallet; and
reconcile the plurality of crypto assets between the offline wallet and the online wallet based on the generated smart contract and a public address, wherein the reconciling comprises transferring by the blockchain network a pre-defined number of a plurality of packets containing at least one of: a first part of a private multi-signature key and a second part of the multi-signature private key.

10. The system of claim 9, wherein the one or more hardware processors are configured to:
generate the offline wallets comprising an offline computer system and a printer;
print a plurality of multi-signature private keys which are individually sealed and are catalogued in a vault; and
send a public address associated with each of the offline computer system and the printer to the blockchain network for registering the offline computer system and the printer.

11. The system of claim 9, wherein the reconciling further comprises:
scanning the first part of the multi-signature private key stored in a multi sign envelope based on a first authorization/instruction received from the smart contract;
sending the scanned first part of the private multi-signature key to the blockchain network;
in response to receiving the scanned first part of the multi-signature private key, authorizing the trading platform to view the second part of the multi-signature private key;
scanning the second part of the multi-signature private key stored in a multi sign envelope based on a second authorization/instruction received from the smart contract; and
sending the scanned second part of the multi-signature private key to the blockchain network.

12. The system of claim 9, wherein the one or more hardware processors are further configured to register each of the plurality of packets on the smart contract, wherein equal denomination multi signature private keys are stored in each of the packets, wherein each packet contains at least one of: the first part of the multi-signature private key and the second part of the multi-signature private key, and a serial number, and a public address, wherein the plurality of multi-signature private keys are required to sign a single transaction.

13. The system of claim 9, wherein the reconciliation of the plurality of crypto assets between the offline wallet and the online wallet is performed after a pre-defined time interval.

14. The system of claim 9, wherein the offline wallet corresponds to a cold storage.

15. The system of claim 9, wherein the online wallet corresponds to a hot storage.

16. The system of claim 9, wherein an operator has access to only one half of one packet at any instant of time, wherein the operator receives additional access to the vault after each confirmation on the blockchain.

17. A non-transitory computer-readable storage medium storing instructions which when executed by a processor enable the processor to execute a method of scalable reconciliation of a plurality of crypto assets between an offline wallet and an online wallet in a blockchain network, the method comprising:
receiving a request for reconciliation of a plurality of transactions from a computing system associated with a trading platform;
triggering the blockchain network to generate a smart contract, wherein the smart contract comprises information indicative of a quantity of the plurality of crypto assets to be shifted between the offline wallet and the online wallet; and
reconciling the plurality of crypto assets between the offline wallet and the online wallet based on the generated smart contract and a public address, wherein the reconciling comprises transferring by the blockchain network a pre-defined number of a plurality of packets containing at least one of: a first part of a private multi-signature key and a second part of the multi-signature private key.
